(19) United States
(12) Patent Application Publication
(10) Pub. No.: US 2004/0226429 A1
(43) Pub. Date: Nov. 18, 2004

(54) Cutoff wheel for hand power tools

(76) Inventor: Mike Voigt, Gaildorf (DE)

Correspondence Address: STRIKER, STRIKER & STENBY, 103 East Neck Road, Huntington, NY, 11743, US

(21) Appl. No.: 10/843,021

(22) Filed: May 11, 2004

(30) Foreign Application Priority Data
May 13, 2003 (DE) 103 21 629.4

(51) Int. Cl. B27B 13/02

(52) U.S. Cl. 83/835

(57) ABSTRACT

A cutoff disc, having an outer periphery provided with particles which are released during wear, a central opening for passage and clamping on a work spindle for the rotary driving on a grinding hand power tool, and an outer ring region which is provided on an outer edge, the outer ring region extending radially outwardly with a tip and forming a small cutting edge.

### BACKGROUND OF THE INVENTION

The present invention relates to a cutoff wheel for hand power tools.

The present invention relates to a cutoff wheel for hand power tools. Many cutoff wheels for cutoff by grinding are known in the art. One of them is disclosed for example in German patent DE 102 08 818 C1. In this document the cutoff wheel is clamped with a central recess on a working spindle of a grinding power tool and hand guided for workpieces of any type. In particular it can be used for cutoff works, and in some cases also for smoothing of weld or solder seams on metal workpieces or for removal of non uniformities of concrete parts.

The known cutoff wheels have the disadvantage that due to unavoidable more or less great eccentric position of the periphery of the cutoff wheel with respect to the rotary axis of the grinding hand power tool, in the beginning of the grinding or cutting process only a small region of the periphery of the cutoff wheel engages in the material to be treated. This region of the cutoff wheel which comes first in engagement is overloaded in the case of hard loading, so that individual cutting segments of the periphery can rectify and their cutting action is lost, or in the case of massive overheating of a peripheral region or a soldered segment it is released from the cutoff wheel, and it can not be used any longer. Moreover, the cutting off wheel has a tendency to disturbing vibrations due to the non uniform engagement with the workpiece. Thereby the cutting efficiency and the material removal with this cutoff disc is reduced when compared with an ideally centered cutoff discs, while on the other hand the ideal centering means unacceptably high manufacturing expenses.

### SUMMARY OF THE INVENTION

Accordingly, it is an object of the present invention to provide a cutoff wheel which avoids the disadvantages of the prior art.

In keeping with these objects and with others which will become apparent hereinafter, one feature of the present invention, resides, briefly stated, in a cutoff disc for a hand power tool, having an outer periphery provided with particles which are released during wear; a central opening for passage and clamping on a work spindle for the rotary driving on a grinding hand power tool; and an outer ring region which is provided on an outer edge, said outer ring region extending radially outwardly with a tip and forming a small cutting edge.

When the cutoff disc is designed in accordance with the present invention, it has the advantage that its initial eccentricity with respect to the working spindle of the grinding hand power tool is eliminated after several revolutions during the engagement with the workpiece, a uniform workpiece engagement is provided, a local overheating of the cutoff disc is excluded, and a vibration-free grinding is possible.

The cutting efficiency and the material removal of the cutoff is increased and the surface life of he cutting disc is significantly improved.

Since the conventional cutoff discs on their outer edge have a thicker outer ring region up to 2 millimeters which extends radially outwardly to a tip and form a central, relatively thin disc, its thinnest part which is located in engagement of the workpiece is worn relatively fast in a self-centering manner during the first grinding revolutions. Thereby, the above mentioned eccentricity-related disadvantages are quickly eliminated.

An outer ring on an outer edge of the cutoff disc is composed of a material which is significantly softer and wears faster than the remaining region of the cutoff disc, and therefore the outer ring is removed relatively fast in the self-centering manner and the cutoff disc thereby becomes optimally operational.

The cutoff discs can be used in pairs for milling of masonry grooves. Thereby the eccentricity-reducing action and the service time of the double running unit are significantly increased.

When the cutoff disc is formed as a diamond cutoff disc and its periphery is subdivided into tooth segments and tooth gaps, its service life, in particular the connection between the tooth segments and the main blade is improved and the service life of the cutoff disc is increased.

The tooth segments can carry each a partial ring region which is softer and wears faster than the tooth segment, and this partial ring region can be interrupted on the tooth gaps, so that the cutoff disc has a self-cooling with an improved service life.

Each part-ring region can be designed roof-shaped with a tip and can form a relatively thin or sharp edge which is smaller than the thickness of the cutoff disc or the main blade. In this case, the partial ring region can be composed of the same material as the toothed segments. Thereby, the eccentricity-reducing action is obtained only by the formation of the outer edge of the cutoff disc.

The ring region can have a softer bond of its abrasive particles than the remaining region of the cutoff disc. Therefore first a finer chip removal during the engagement with the workpiece is provided than after the wear of the outer ring during engagement with the highly efficient cutting region of the cutoff disc. Thereby the handling of the grinding hand power tools provided with the corresponding cutoff discs is substantially controllable and the accident danger in case of unintentional drop of the machine with the abruptly reacting, aggressive chip removal is excluded.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a grinding hand power tool with a cutoff disc in accordance with the present invention;

FIG. 2 is a view showing a flat side of the cutoff disc in accordance with the present invention;

FIG. 3 is a view showing a flat side of a further embodiment of the cutoff disc in accordance with the present invention; and

FIG. 4 is a view showing a small side of the cutoff disc of FIG. 3 in accordance with the present invention.

### DESCRIPTION OF THE PREFERRED EMBODIMENTS

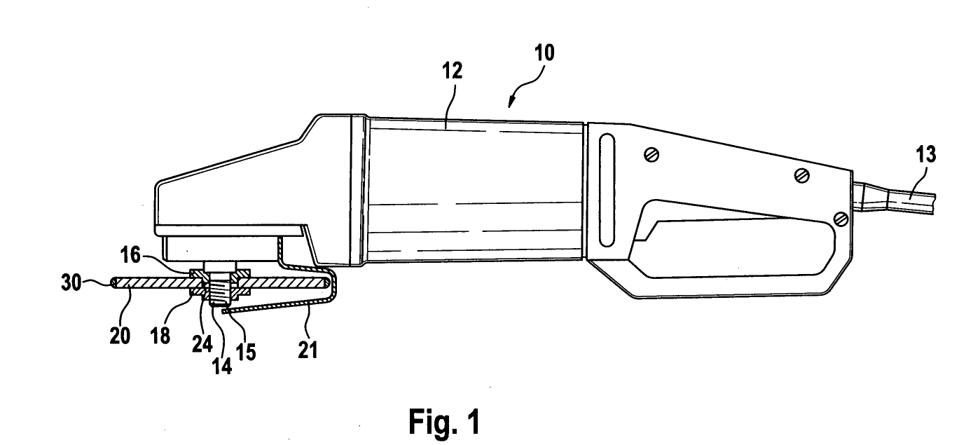

A grinding hand power tool shown on a side view in FIG. 1 is designed as an angle grinder 10. It has a longitudinally extending machine housing 12 with not identified handle arranged at its rear end, and with an electric cable 13 extending from its end for energy supply of a not shown motor.

A not shown switching key for turning on and off of the not shown motor is arranged in the region of the handle and is easily acceptable for an operator. The housing 12 at its front end has a work spindle 14 which extends perpendicular to the longitudinal extension of the machine housing 12 and serves for a rotary drive of a cutoff wheel 20 which is clamped in it for joint rotation therewith.

The cutoff disc 20 has a central opening 24 for setting on the work spindle 14 which extends through the cutoff disc 20. A clamping nut 18 is screwed on the free end of the work spindle 14, in particular on its thread 15. The clamping nut 18 presses the cutoff disc 20 axially to a holding flange 16, so that the cutoff disc 20 is clamped in a force-transmitting manner for joint rotation with the workspindle 14.

The cutoff disc 20 is surrounded by a protective hood 21 in its rear region which faces the electrical cable 13. Therefore, during operation with the angle grinder 10 the operator can not be subjected to the action of chip and grinding dust or the like.

The cutoff disc 20 on its outer edge has an outer ring 30. It has a different binding means composition and grinding means composition when the remaining region of the cutoff disc 20 provided for cutting. The outer ring 30 in a radial direction has a thickness of substantially 5 millimeters and substantially the same thickness as the cutoff disc 20.

The cutoff disc 20 has a certain eccentricity of its outer periphery relative to a center point of the central recess 24 due to its manufacture. Thereby, in operation of the angle grinder 10 during the rotation of the cutoff disc 20 a non uniform engagement of its periphery in the workpiece to be treated takes place. This can be also the result of an oval form of the cutoff disc which deviates from the ideal circular shape.

Since the outer ring 30 is worn relatively fast, for example during several revolutions of the cutoff disc 20 in engagement with the workpiece, the eccentricity of the outer periphery of the cutoff disc 20 is automatically compensated. Thereby, in shortest time, a uniform workpiece engagement without vibration and local overheating of the cutoff disc 20 is provided.

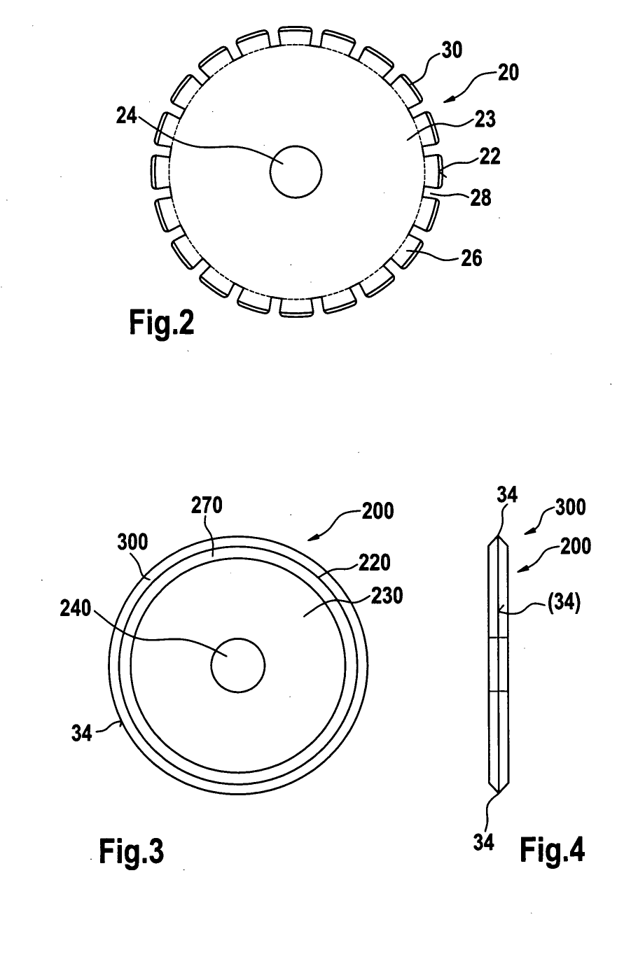

FIG. 2 shows a cutoff disc in a plan view on its circular surface. The outer edge 22 can be clearly seen in this drawing. It ends with the outer edge of the cutting segment 26 and is formed by it. The cutting segments 26 are arranged at equal distances relative to one another to form segment gaps 28 therebetween. The cutting segments 26 are composed of a sintered abrasive binder mixture. Each individual segment 26 is connected with the circular main blade 23 in a material-connecting manner, for example by soldering or welding. This connection is relatively sensitive to thermal overloading, so that such a thermal overloading has to be avoided.

On the outer edge 22 of the cutting segments 26 an outer ring 30 is applied over its width in a ring segment-like manner. Its composition, as described with respect to FIG. 1 is selected so as to be worn out intentionally fast. Thereby, a manufacturing-related deviation of the center of the outer edge 52 and the center of the central recess 24 is compensated after several revolutions of the cutoff disc 20 in engagement with the workpiece. FIG. 3 shows a cutoff disc 200. Its cutting region 270 is not subdivided into individual segments, but instead is formed as a throughgoing ring which is soldered or welded on a main blade 230 of the cutoff disc 200.

Starting from the circular outer edge 220 of the cutoff disc 20, a prismatically designed outer ring region 300 follows. It forms a relatively sharp-edge, thin and tip-shaped cutting blade 34. The cutoff disc 20 has a central recess 240 in its center.

FIG. 4 shows a small side of the cutoff disc 20. The prismatic shape of the outer region ring 300 and the cutting region 34 can be clearly seen in this drawing. Due to the prismatic design of the outer ring region 300 with the same material composition as in the cutting region 270, a same action is obtained only by this geometry, as with the outer ring 30 composed of a softer mixture of FIG. 2. The tip-shaped region 34 of the outer ring region 300 wears relatively fast during cutting. Therefore an eccentricity of the outer periphery 34 or 220 relative to the central point of the central recess 24 is compensated in a very short time.

It will be understood that each of the elements described above, or two or more together, may also find a useful application in other types of constructions differing from the types described above.

While the invention has been illustrated and described as embodied in cutoff wheel for hand power tools, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A cutoff disc, having an outer periphery provided with particles which are released during wear; a central opening for passage and clamping on a work spindle for the rotary driving on a grinding hand power tool; and an outer ring region which is provided on an outer edge, said outer ring region extending radially outwardly with a tip and forming a small cutting edge.

2. A cutoff disc as defined in claim 1; and further comprising cutting means selected from the group consisting of a cutting region and cutting segments and provided with said outer edge, said outer ring region having an outer ring which surrounds said outer edge and being formed so as to wear faster than said cutting means.

3. A cutoff disc as defined in claim 1, wherein said cutting means start radially inwardly at a distance of substantially 5mm from said outer edge.

4. A cutoff disc as defined in claim 1; and further comprising a second such cutoff disc which is axially spaced from said first mentioned cutoff disc, said two cutoff disc being arrangable in pair on the work spindle of the grinding hand power tool formed as a masonry groove mill.

5. A cutoff disc as defined in claim 1, wherein the cutoff disc is formed as a diamond cutoff disc including a main blade and a plurality of toothed segments separated from one another by segment gaps.

6. A cutoff disc as defined in claim 1, wherein the tooth segments each carry a part of the outer ring region which is formed so as to be worn faster than said toothed segment.

7. A cutoff disc as defined in claim 5, wherein each part ring region is formed roof-shaped prismatic and with a tip and forms a circumferentially small cutting edge which is smaller than a thickness of the main blade.

8. A cutoff disc as defined in claim 2, wherein said outer ring region is composed of a softer binder and another mixture of abrasive particles than the cutting means.
